(19) United States
(12) Patent Application Publication
(10) Pub. No.: US 2010/0018237 A1
(43) Pub. Date: Jan. 28, 2010

(54) Low Water Consumption Cooling Tower for Gasification Plants

(75) Inventor: Paul Steven Wallace, Katy, TX (US)

Correspondence Address: KING & SPALDING, LLP, 1100 LOUISIANA ST., STE. 4000, ATTN.: IP Docketing, HOUSTON, TX, 77002-5213, US

(73) Assignee: Hunton Energy Holdings, LLC, Houston, TX (US)

(21) Appl. No.: 12/353,821

(22) Filed: Jan. 14, 2009

Related U.S. Application Data
(60) Provisional application No. 61/084,070, filed on Jul. 28, 2008.

(51) Int. Cl. F28D 5/00; B01F 3/04; F28F 1/10

(52) U.S. Cl. 62/314; 261/161; 261/128; 165/181

(57) ABSTRACT

Disclosed is a hybrid cooling tower and a method and system for using the cooling tower. The cooling tower is design to reduce water consumption and eliminate plume formation. The cooling tower comprises a wet section having a plurality of wet section fans and a dry section having a plurality of dry section fans. The wet section fans are adjustable to operate at an increased rate and a reduced rate, depending upon ambient conditions surrounding the cooling tower. The wet section may comprise at least one shutter door. In operation, typically the wet section fans operate at the increased rate during a summer peak price period and at the reduced rate during a winter peak price period and an offpeak price period. Typically, the dry section fans operate at the increased rate all year. This method allows for less evaporative cooling and more latent cooling thereby reducing water consumption.

### CROSS REFERENCE TO RELATED APPLICATIONS

The present application is related to U.S. patent application Ser. No. 12/351,515, entitled “Power Management for Gasification Facility” and filed on Jan. 9, 2009, and U.S. Provisional Patent Application No. 61/084,070, entitled “Zero Discharge Waste Water System for Gasification Plants” and filed on Jul. 28, 2008, which are all assigned to the assignee of the present application. Each of these related applications are incorporated by reference in its entirety herein.

### TECHNICAL FIELD

This invention relates generally to a cooling tower used for cooling a fluid, typically water, and, more particularly, to a hybrid cooling tower having a dry section and a wet section and a method of operating the hybrid cooling tower.

### BACKGROUND

A cooling tower operates to cool water from a high temperature to a low temperature so that the water may be recycled, thereby providing a continuous supply of cooling water to a particular process application. Some process applications include, but are not limited to, refrigeration systems, an air separation unit inlet cooling system, industrial plants, for example, integrated gasification and combined cycle (“IGCC”) plants, and any other process application having heat exchangers.

Cooling towers are highly efficient and cost effective means of dissipating heat from the high temperature water. Operation of a cooling tower typically involves spraying the heated water over one or more mixing elements and simultaneously drawing a cooler air stream into the cooling tower from its side surroundings so that heat exchange may occur between the heated water and the cooler air stream. Thus, the heated water becomes cooler and the cooler air stream becomes a saturated air stream. The saturated air stream then usually exits the top of the cooling tower through an opening. The exiting saturated air stream may condense and exit in the form of visible plume, non-visible vapor, or a combination of both.

However, cooling towers have certain drawbacks associated with it. One obvious drawback to cooling towers is that under certain atmospheric conditions, a visible plume may be created by moisture from the heated water evaporating into the air stream being carried out of the top of the cooling tower. In industrial plants, the cooling tower is usually very large and therefore the visible plume may also be very large, which can cause certain potential issues within the vicinity of the cooling tower. First, the visible plume may form low lying fog in the vicinity of the cooling tower, which may cause hazardous road conditions and/or certain work hazard conditions due to reduce visibility. In some extreme cases, visibility may be only a few feet. Second, the visible plume may also cause icing to occur on roads or structures within the vicinity of the cooling tower where colder temperatures cause the moisture in the visible plume to freeze. The icing also causes hazardous road conditions and/or certain work hazard conditions due to slippery conditions on roads, walkway, etc. Third, the visible plume may cause corrosion or ice formation on components located in the vicinity of the cooling tower. Fourth, the visible plume may draw complaints and objections from local residents.

Another drawback to cooling towers is the high rate of water consumption that occurs. The high rate of water consumption causes certain issues to arise within the process system itself. First, due to the high rate of water consumption, additional water must be periodically injected into the cooling system so that it may compensate for the high rate of water consumption that is occurring. This water consumption may be a substantial amount over a course of one year and the make-up water supply may be available in limited quantities for many industrial plants. Second, when the water is consumed, the concentration of the impurities is increased within the water remaining in the cooling tower, which will therefore require a portion of the remaining water to undergo a blowdown once the impurity level in the remaining water reaches an unacceptable pre-determined level. During a blowdown, a portion of the remaining water is removed from the cooling tower and is then purified prior to being recycled back to the cooling tower. Thus, the higher the rate of water consumption, the higher the rate of blowdown that is required.

As a result of the visible plume formation and the high water consumption, an abundance of land must be made available around the cooling tower so that these potential issues are minimized or eliminated. Additionally, the maximum capacity of the industrial plant is limited due to the land requirements and the required amounts of water. The land requirements result in less available land for additional industrial plant capacity and also a reduced utilization factor for common facilities and infrastructure (docks, roads, warehouses, etc.), thereby limiting the possible economies of scale for the industrial plant.

One type of cooling tower is a hybrid cooling tower having a dry section and a wet section. These hybrid cooling towers are commercially proven cooling towers. However, these hybrid cooling towers are designed and operated in order to minimize visible plume. These hybrid cooling towers have not been designed or operated to minimize water consumption.

As previously mentioned, the visible plume does not necessarily correspond to the water consumption that is occurring in the system. Although, the visible plume exhibits water consumption that is occurring within the process system, the visible plume does not reflect the total water consumption that is occurring. For example, the visible plume may be minimized by re-evaporating the saturated air stream by blowing hot air across it so that the moisture within the saturated air stream is evaporated prior to exiting the top of the cooling tower. Thus, the visible plume is minimized, but the water consumption remains the same because the same amount of water is exiting the top of the cooling tower as visible plume and non-visible vapors.

In a hybrid cooling tower, there are provisions to turn off airflow through the air fan, or dry section, but no provisions exist to turn off airflow through just the wet section. This is because the dry section requires more fan power per unit of cooling than the wet section. Thus, the dry section is only operated at the rate required to minimize the visible plume.

Currently, IGCC plants usually use these conventional wet cooling towers. The typical IGCC plant consumes over five tons of water per ton of coal or coke feed. This high rate of water consumption limits the potential project sites for large scale gasification plants due to the visible plume formation and the high water requirements. Site flexibility is critical for CO₂ capture since there are only a limited number of locations where CO₂ can be profitably sequestered for enhanced oil recovery. In addition to the high rate of water consumption, current IGCC plants are operated as baseload plants even when market power pricing rewards peak operation.

In view of the foregoing discussion, need is apparent in the art for providing cooling towers so that they are designed to minimize the rate of water consumption. Additionally, a need is apparent for improving cooling towers that are designed to further minimize the visible plume formation. Further, there exists the need for providing a method to operate the cooling towers to increase the rate of return according to market demands. Moreover, there exists a need for providing a method to efficiently operate the cooling towers in an IGCC plant so that pricing rewards may be achieved during peak times. A technology addressing one or more such needs, or some other related shortcoming in the field, would benefit processes utilizing a cooling tower, for example a gasification plant. This technology is included within the current invention.

### SUMMARY

According to one embodiment, a hybrid cooling tower comprises a wet section and a dry section, wherein the dry section is adjacently positioned above the wet section and the dry section is fluidly communicable with the wet section. The wet section comprises at least one wet section air inlet and at least one wet section shutter door adjacent the at least one wet section air inlet. The at least one wet section shutter door is adjustable to assist in controlling the amount of ambient air entering through the at least one wet section air inlet.

According to another embodiment, a gasification facility comprising a refrigeration/ice storage system and a hybrid cooling tower for supplying a cooled water to the refrigeration/ice storage system.

According to another embodiment, a method of operating a hybrid cooling tower comprising placing a hybrid cooling tower having a plurality of wet section fans in fluid communication with at least one equipment requiring cooled water from the hybrid cooling tower and adjusting the rate of the plurality of wet section fans depending upon the ambient conditions surrounding the hybrid cooling tower. The hybrid cooling tower comprises a wet section and a dry section. The wet section comprises at least one wet section air inlet and the plurality of wet section fans positioned adjacent the at least one wet section air inlet. At least one wet section fan is adjustable to perform at an increased rate and a reduced rate. The dry section is adjacently positioned above the wet section and the dry section is fluidly communicable with the wet section.

According to another embodiment, a gasification facility comprising a hybrid cooling tower for supplying a cooled water to the gasification facility. The hybrid cooling tower comprises a wet section and a dry section, wherein the dry section is adjacently positioned above the wet section and the dry section is fluidly communicable with the wet section. The wet section comprises at least one wet section air inlet and at least one wet section shutter door adjacent the at least one wet section air inlet. The at least one wet section shutter door is adjustable to assist in controlling the amount of ambient air entering through the at least one wet section air inlet.

### BRIEF DESCRIPTION OF THE DRAWINGS

The foregoing and other features and aspects of the invention will be best understood with reference to the following description of certain exemplary embodiments of the invention, when read in conjunction with the accompanying drawings, wherein:

FIG. 1 shows a schematic view of a round hybrid cooling tower and a process utilizing the round hybrid cooling tower in accordance with an exemplary embodiment;

FIG. 2 shows a schematic view of a cell type hybrid cooling tower and a process utilizing the cell type hybrid cooling tower in accordance with an exemplary embodiment;

FIG. 3 is a graph 400 illustrating an exemplary embodiment of wholesale power pricing in and around Houston, Tex., USA, for a single day in June, 2008 in accordance with an exemplary embodiment.

FIG. 4 shows a table comparing the operating requirements, including water consumption requirements and land space requirements, for various types of power producing plants in accordance with an exemplary embodiment;

FIG. 5A shows a bar chart comparing water consumption requirements in the various types of power plants in accordance with an exemplary embodiment provided in FIG. 4;

FIG. 5B shows a bar chart comparing land requirements for various types of power plants in accordance with an exemplary embodiment provided in FIG. 4; and

FIG. 6 shows a table depicting various design parameters of a hybrid cooling tower for various time periods throughout the year in accordance with an exemplary embodiment.

The drawings illustrate only exemplary embodiments of the invention and are therefore not to be considered limiting of its scope, as the invention may admit to other equally effective embodiments.

### BRIEF DESCRIPTION OF EXEMPLARY EMBODIMENTS

The application is directed to hybrid cooling towers and methods for operating hybrid cooling towers. In one operational example, the hybrid cooling tower is directed to provide cooling to at least an ice refrigeration storage system which can thereby control the electrical loads for the larger consumers of cooling in a gasification unit. The ice refrigeration storage system allows SNG production facilities to maximize the export of power during peak price periods, minimize the export of power during offpeak price periods, control the export of power during mid-peak price periods, and supply power during emergency peak periods. As used herein, the term “peak price period” refers to a time period, typically mid-day, during which power demand is at a maximum and the market price of the power is at a premium. As used herein, the term “offpeak price period” refers to a time period, typically night, during which power demand is at a minimum and the market price of the power is the lowest. As used herein, the term “mid-peak price period” refers to time periods, typically morning and evening, between the peak and offpeak price periods. As used herein, the term “emergency peak period” refers to a time period, typically 1-2 hours, during impending blackout conditions.

The invention may be better understood by reading the following description of non-limiting, exemplary embodiments with reference to the attached drawings, wherein like parts of each of the figures are identified by the same reference characters, and which are briefly described as follows.

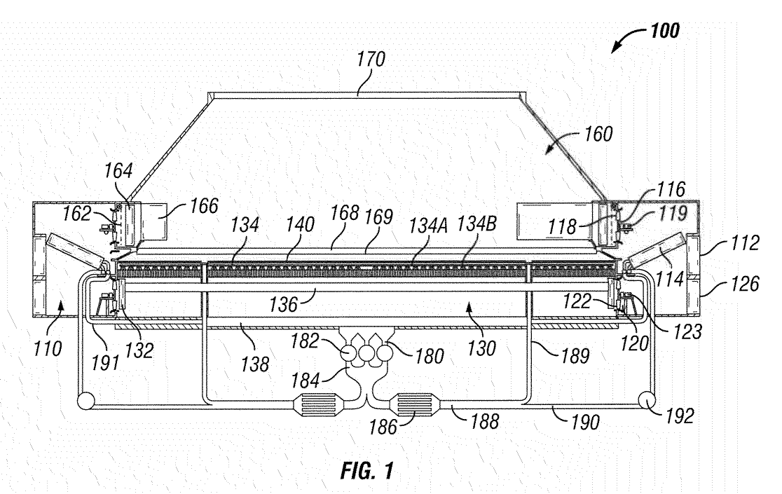

FIG. 1 shows a schematic view of a round hybrid cooling tower and a process utilizing the round hybrid cooling tower in accordance with an exemplary embodiment. The round hybrid cooling tower 100 has been designed for low or no plume formation and for water conservation. The round hybrid cooling tower 100 comprises an air chamber 110, a wet section 130, and a dry section 160. The air chamber 110 surrounds the wet section 130 and the bottom portion of the dry section 160. Since a cross-section of the round hybrid cooling tower 100 is shown in FIG. 1, it appears that there is a left side and a right side to the round hybrid cooling tower 100. However, the round hybrid cooling tower 100 should be viewed as being circular and that certain parts and devices are located circumferentially around the round hybrid cooling tower 100.

The air chamber 110 comprises at least one ambient air inlet 112, a plurality of finned tube heat exchangers 114, at least one dry section air inlet 116, a plurality of dry section fans 118, a dry section fan motor 119 for each of the plurality of dry section fans 118, at least one wet section air inlet 120, a plurality of wet section fans 122, and a wet section fan motor 123 for each of the plurality of wet section fans 122. Additionally, the air chamber 110 may comprise at least one air chamber sound attenuator 126 surrounding at least a portion of the exterior circumference of the air chamber 110.

The at least one ambient air inlet 112 communicates ambient air from the lower exterior surroundings of the round hybrid cooling tower 100 to within the air chamber 110. The ambient air comprises a first portion and a second portion. The first portion of this ambient air is directed to the dry section 160 via the plurality of finned tube heat exchangers 114, while the second portion of the ambient air is directed to the wet section 130. During certain operating circumstances, a majority of the ambient air entering the air chamber 110 may be directed to the dry section 160, which will be further explained below.

The plurality of finned tube heat exchangers 114 are positioned to surround the entire round hybrid cooling tower 100. According to this embodiment, the plurality of finned tube beat exchangers 114 are positioned at an angle so that the first portion of the ambient air entering the air chamber 100 is directed through the plurality of finned tube heat exchangers 114 such that a first portion of the hot cooling water passing within the plurality of finned tube heat exchangers 114 is cooled and the first portion of the ambient air passing through the plurality of fumed tube heat exchangers 114 is heated. The heated first portion of the ambient air is then forced through the at least one dry section air inlet 116 via the plurality of dry section fans 118. Although some embodiments may utilize the plurality of finned tube heat exchangers, alternative embodiments may utilize different types of heat exchangers or a combination of various types of heat exchangers without departing from the scope and spirit of the exemplary embodiment. Additionally, although the plurality of finned tube heat exchangers 114 are illustrated as positioned at an angle, the plurality of finned tube heat exchangers 114 may be positioned at any angle varying from horizontal to vertical without departing from the scope and spirit of the exemplary embodiment.

The at least one dry section air inlet 116 communicates the heated first portion of the ambient air from the air chamber 110 to the dry section 160. The at least one dry section air inlet 116 may surround the entire dry section 160 as a continuous dry section air inlet or may be partitioned into several dry section air inlets surrounding the dry section 160.

The plurality of dry section fans 118 are located within the at least one dry section air inlet 116. The plurality of dry section fans 118 force the heated first portion of the ambient air from the air chamber 110 to the dry section 160. In the situation where the at least one dry section air inlet 116 is a continuous dry section air inlet, the plurality of dry section fans 118 may be uniformly spaced apart around the continuous dry section air inlet. Although some embodiments may have the plurality of dry section fans 118 uniformly spaced apart, the plurality of dry section fans 118 may be arbitrarily spaced apart around the continuous dry section air inlet without departing from the scope and spirit of the exemplary embodiment. In the situation where the at least one dry section air inlet 116 is partitioned into several dry section air inlets, the plurality of dry section fans 118 may be positioned such that each dry section air inlet has a single dry section fan. Although some embodiments may have a single dry section fan for each dry section air inlet, alternative embodiments may have a plurality of dry section fans 118 spaced apart, either uniformly or arbitrarily, within each of the dry section air inlets without departing from the scope and spirit of the exemplary embodiment.

The dry section fan motor 119 is associated for each of the plurality of dry section fans 118. The dry section fan motor 119 may be a variable speed motor so that the speed of the corresponding dry section fan may be controlled and made faster or slower depending upon the process requirements.

The at least one wet section air inlet 120 communicates the second portion of the ambient air from the air chamber 110 to the wet section 130. The at least one wet section air inlet 120 may surround the entire wet section 130 as a continuous wet section air inlet or may be partitioned into several wet section air inlets surrounding the wet section 130.

The plurality of wet section fans 122 are located within the at least one wet section air inlet 120. The plurality of wet section fans 122 force the second portion of the ambient air from the air chamber 110 into the wet section 130. In the situation where the at least one wet section air inlet 120 is a continuous wet section air inlet, the plurality of wet section fans 122 may be uniformly spaced apart around the continuous wet section air inlet. Although some embodiments may have the plurality of wet section fans 122 uniformly spaced apart, the plurality of wet section fans 122 may be arbitrarily spaced apart around the continuous wet section air inlet without departing from the scope and spirit of the exemplary embodiment. In the situation where the at least one wet section air inlet 120 is partitioned into several wet section air inlets, the plurality of wet section fans 122 may be positioned such that each wet section air inlet has a single wet section fan. Although some embodiments may have a single wet section fan for each wet section air inlet, alternative embodiments may have a plurality of wet section fans 122 spaced apart, either uniformly or arbitrarily, within each of the wet section air inlets without departing from the scope and spirit of the exemplary embodiment.

The wet section fan motor 123 is associated for each of the plurality of wet section fans 122. The wet section fan motor 123 may be a variable speed motor so that the speed of the corresponding wet section fan may be controlled and made faster or slower depending upon the process requirements.

Additionally, according to some embodiments, the air chamber 110 may comprise at least one air chamber sound attenuator 126 surrounding at least a portion of the exterior circumference of the air chamber 110. The at least one air chamber sound attenuator 126 is designed to reduce the noise created within the round hybrid cooling tower 100. The at least one air chamber sound attenuator 126 may surround the entire exterior circumference of the air chamber 110 as a continuous sound attenuator or may be partitioned into several sound attenuators surrounding the exterior circumference of the air chamber 110. Although air chamber sound attenuators are shown at the exterior circumference of the air chamber 110, other sound reduction devices may be positioned at the exterior circumference of the air chamber 110 without departing from the scope and spirit of the exemplary embodiment. Alternatively, according to some embodiments, there may be no air chamber sound attenuators positioned at the exterior circumference of the air chamber 110 without departing from the scope and spirit of the exemplary embodiment.

The wet section 130 is round shaped and comprises at least one wet section shutter door 132, a water distribution device 134, a wet section cooling fill 136, and a water tank 138. Additionally, the wet section 130 may comprise a wet section drift eliminator 140 located above the plurality of water distribution devices 134.

The at least one wet section shutter door 132, or wet section louver, is located adjacent to the plurality of wet section fans 122. The at least one wet section shutter door 132 may surround the entire circumference of the wet section 130 as a continuous wet section shutter door or may be partitioned into several wet section shutter doors surrounding the wet section 130, wherein each of the wet section shutter door corresponds to each of the at least one wet section air inlet 120. The at least one wet section shutter door 132 controls and guides the inflow of the second portion of the ambient air into the wet section 130 of the round hybrid cooling tower 100. The at least one wet section shutter door 132 may be adjustable to be fully closed, partially open, or fully open depending upon the process requirements. These at least one wet section shutter door 132 controls how much of the second portion of the ambient air is allowed to enter the wet section 130. These at least one wet section shutter door 132 may also prevent water droplets which flow downward through the wet section cooling fill 136, from drifting out of the round hybrid cooling tower 100.

The water distribution device 134 for distributing high temperature water within the wet section 130 is positioned at the upper portion of the wet section 130. The water distribution device 134 comprises a water distribution pipe 134a through which high temperature water is fed, and a plurality of nozzles 134b, or sprinklers, which are installed on the water distribution pipe 134a. The plurality of nozzles 134b are designed to spray high temperature water through the wet section cooling fill 136 so that heat exchange may occur between the second portion of the ambient air and the high temperature water. The source of the high temperature water is a mixture of the water exiting the plurality of finned tube heat exchangers and from the return water flow from at least a refrigeration system, an air separation unit inlet cooling system, and/or any other process application requiring heat exchange. The second portion of the ambient air is heated, while the high temperature water is cooled. Typically, evaporative cooling occurs within the wet section 130.

The wet section cooling fill 136 is located below the water distribution device 134 and facilitates heat transfer between the second portion of the ambient air and the high temperature water exiting the water distribution device 134. The wet section cooling fill 136 facilitates heat transfer by increasing the surface area between the high temperature water and the second portion of the ambient air. In the wet section cooling fill 136, the second portion of the ambient air exchanges heat with the high temperature water and becomes saturated with water as the second portion of the ambient air exits through the top of the wet section 130. The high temperature water becomes cooled water as it travels downward through the wet section cooling fill 136. Thus, evaporative cooling occurs in the wet section 130. The wet section cooling fill 136 may be a splash fill, a film fill, or any other type of device which provides for improved heat transfer between cooler air and high temperature water. Splash fill comprises of material that interrupts the high temperature water flow by causing splashing to occur, while film fill is composed of thin sheets of material upon which high temperature water flows.

The water tank 138 is located at the bottom of the wet section 130 and collects the cooled water flowing downward through the wet section cooling fill 136. This cooled water may then be fed again to at least a refrigeration system, an air separation unit inlet cooling system, and/or any other process application requiring heat exchange. In some embodiments, a plurality of sensors (not shown) may be positioned within the water tank 138 to monitor the cooled water liquid level and/or the impurity concentration within the cooled water. If the impurity concentration is higher than a predetermined threshold, a blowdown may occur to clean out the impurities and may recycle the cleaned cooled water back into the water tank 138.

Additionally, according to some embodiments, the wet section 130 may comprise a wet section drift eliminator 140 located above the water distribution device 134. The wet section drift eliminator 140 is designed to reduce or prevent drifting of water droplets that is contained in the second portion of the ambient air that is forcibly being discharged from the wet section 130 to the dry section 160.

The dry section 160 is located above the wet section 130 and comprises at least one dry section shutter door 162, at least one dry section perimeter sound attenuator 164, a plurality of mixing elements 166, a hot air passageway 168, and a stack 170. Additionally, the dry section 160 may comprise at least one dry section sound attenuator 169 located at the interface between the dry section 160 and the wet section 130. The dry section 160 has a conical shape, wherein the tapered portion of the conical shape is oriented in a direction traveling away from the wet section 130.

The at least one dry section shutter door 162, or dry section louver, is located adjacent to the plurality of dry section fans 118. The at least one dry section shutter door 162 may surround the entire circumference of the dry section 160 as a continuous dry section shutter door or may be partitioned into several dry section shutter doors surrounding the dry section 160, wherein each of the dry section shutter door corresponds to each of the at least one dry section air inlet 116. The at least one dry section shutter door 162 controls and guides the inflow of the first portion of the ambient air into the dry section 160 of the round hybrid cooling tower 100. The at least one dry section shutter door 162 may be adjustable to be fully closed, partially open, or fully open depending upon the process requirements. However, generally, these at least one dry section shutter door 162 is fully open. Thus, some embodiments may not have the at least one dry section shutter door 162 without departing from the scope and spirit of the exemplary embodiment. This at least one dry section shutter door 162 controls how much of the first portion of the ambient air is allowed to enter the dry section 160.

The at least one dry section perimeter sound attenuator 164 surrounds at least a portion of the exterior circumference of the dry section 160. The at least one dry section perimeter sound attenuator 164 is designed to reduce the noise created within the round hybrid cooling tower 100. The at least one dry section perimeter sound attenuator 164 may surround the entire exterior circumference of the dry section 160 as a continuous perimeter sound attenuator or may be partitioned into several perimeter sound attenuators surrounding the exterior circumference of the dry section 160. Although dry section perimeter sound attenuators are shown at the exterior circumference of the dry section 160, other sound reduction devices may be positioned at the exterior circumference of the dry section 160 without departing from the scope and spirit of the exemplary embodiment. Alternatively, according to some embodiments, there may be no dry section perimeter sound attenuators positioned at the exterior circumference of the dry section 160 without departing from the scope and spirit of the exemplary embodiment.

The plurality of mixing elements 166 are located adjacent to the at least one dry section perimeter sound attenuator 164 and are designed to mix the first portion of the ambient air passing through the at least one dry section air inlet 116 with the saturated heated ambient air exiting the wet section 130 and entering the dry section 160. This mixing heats the saturated heated ambient air so that it is no longer saturated and therefore plume formation is substantially reduced and/or eliminated.

The hot air passageway 168 is a passageway located at the interface between the wet section 130 and the dry section 160. This hot air passageway 168 allows the rising saturated heated ambient air to communicate from the wet section 130 to the dry section 160. Although this embodiment illustrates that the hot air passageway 168 is continuous, some embodiments may have the hot air passageway 168 partitioned without departing from the scope and spirit of the exemplary embodiment.

The stack 170 is located at the upper portion of the dry section 160 and allows the hot air within the dry section 160 to exit to the atmosphere. The stack typically has a smaller diameter than the bottom portion of the dry section 160.

According to one embodiment, the dry section sound attenuator 169 is positioned at the interface between the wet section 130 and the dry section 160. The dry section sound attenuator 169 is designed to reduce the noise created within the round hybrid cooling tower 100. Although a dry section sound attenuator 169 is shown at the interface between the wet section 130 and the dry section 160, other sound reduction devices may be positioned at the interface between the wet section 130 and the dry section 160 without departing from the scope and spirit of the exemplary embodiment. Alternatively, according to some embodiments, there may be no dry section sound attenuators positioned at the interface between the wet section 130 and the dry section 160 without departing from the scope and spirit of the exemplary embodiment.

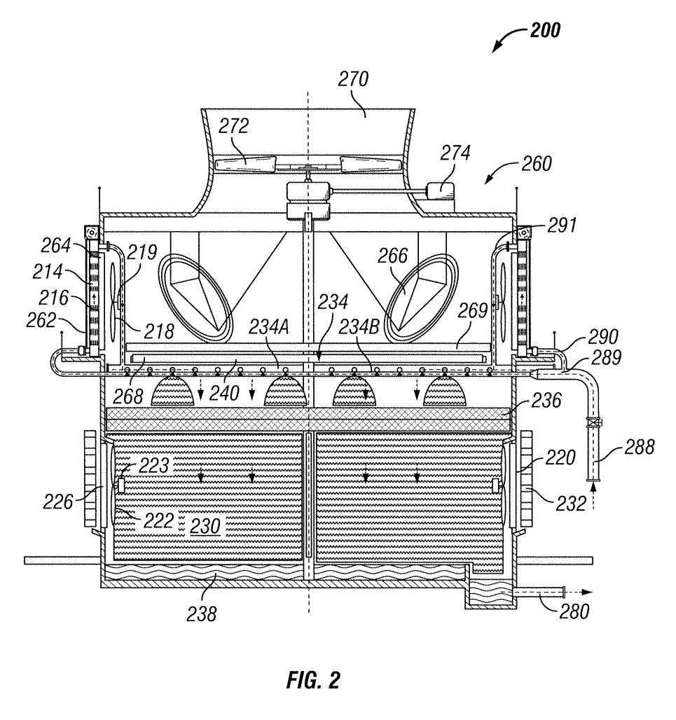

FIG. 2 shows a schematic view of a cell type hybrid cooling tower and a process utilizing the cell type hybrid cooling tower in accordance with an exemplary embodiment. The cell type hybrid cooling tower 200, like the round hybrid cooling tower 100 of FIG. 1, also has been designed for low or no plume formation and for water conservation. The cell type hybrid cooling tower 200 comprises a wet section 230 and a dry section 260. Since a cross-section of the cell type hybrid cooling tower 200 is shown in FIG. 2, it appears that there is a left side and a right side to the cell type hybrid cooling tower 200. However, the cell type hybrid cooling tower 200 should be viewed as being rectangular or square shaped and that certain parts and devices are located circumferentially around the perimeter of the cell type hybrid cooling tower 200.

The wet section 230 is rectangular shaped and comprises at least one wet section air inlet 220, at least one wet section shutter door 232, a water distribution device 234, a wet section cooling fill 236, and a water tank 238. Additionally, according to some embodiments, the wet section 230 may comprise a wet section drift eliminator 240 located above the plurality of water distribution devices 234. Additionally, according to some embodiments, the wet section 230 may also comprise a plurality of wet section fans 222 and a wet section fan motor 223 for each of the plurality of wet section fans 222. Moreover, according to some embodiments, the wet section 230 may also comprise at least one wet section sound attenuator 226 surrounding at least a portion of the perimeter of the wet section 230.

The at least one wet section air inlet 220 communicates ambient air from the lower exterior surroundings of the cell type hybrid cooling tower 200 to within the wet section 230. The at least one wet section air inlet 220 may surround the entire wet section 230 as a continuous wet section air inlet or may be partitioned into several wet section air inlets surrounding the wet section 230.

The at least one wet section shutter door 232, or wet section louver, is located adjacent to the at least one wet section air inlet 220. The at least one wet section shutter door 232 may surround the entire perimeter of the wet section 230 as a continuous wet section shutter door or may be partitioned into several wet section shutter doors surrounding the wet section 230, wherein each of the wet section shutter door corresponds to each of the at least one wet section air inlet 220. The at least one wet section shutter door 232 controls and guides the inflow of the ambient air into the wet section 230 of the cell type hybrid cooling tower 200. The at least one wet section shutter door 232 may be adjustable to be fully closed, partially open, or fully open depending upon the process requirements. The at least one wet section shutter door 232 controls how much of the ambient air is allowed to enter the wet section 230. This at least one wet section shutter door 232 may also prevent water droplets which flow downward through the wet section cooling fill 236, from drifting out of the cell type hybrid cooling tower 200. Although the at least one wet section shutter door 232 has been illustrated as being located on the exterior side of the at least one wet section air inlet 220, the at least one wet section shutter door 232 may be located on the interior side or within the at least one wet section air inlet 220 without departing from the scope and spirit of the exemplary embodiment.

The water distribution device 234 for distributing high temperature water within the wet section 230 is positioned at the upper portion of the wet section 230. The water distribution device 234 comprises a water distribution pipe 234a through which high temperature water is fed, and a plurality of nozzles 234b, or sprinklers, which are installed on the water distribution pipe 234a. The plurality of nozzles 234b are designed to spray high temperature water through the wet section cooling fill 236 so that heat exchange may occur between the ambient air entering the wet section 230 and the high temperature water. The source of the high temperature water is a mixture of the water exiting a plurality of finned tube heat exchangers, which will be further described with respect to the dry section 260, and from the return water flow from at least a refrigeration system, an air separation unit inlet cooling system, and/or any other process application requiring heat exchange. The ambient air within the wet section 230 is heated, while the high temperature water is cooled. Typically, evaporative cooling occurs within the wet section 230.

The wet section cooling fill 236 is located below the water distribution device 234 and facilitates heat transfer between the ambient air within the wet section 230 and the high temperature water exiting the water distribution device 234. The wet section cooling fill 236 facilitates heat transfer by increasing the surface area between the high temperature water and the ambient air within the wet section 230. In the wet section cooling fill 236, the ambient air exchanges heat with the high temperature water and becomes saturated with water as the ambient air exits through the top of the wet section 230. The high temperature water becomes cooled water as it travels downward through the wet section cooling fill 236. Thus, evaporative cooling occurs in the wet section 230. The wet section cooling fill 236 may be a splash fill, a film fill, or any other type of device which provides for improved heat transfer between cooler air and high temperature water. Splash fill comprises of material that interrupts the high temperature water flow by causing splashing to occur, while film fill is composed of thin sheets of material upon which high temperature water flows.

The water tank 238 is located at the bottom of the wet section 230 and collects the cooled water flowing downward through the wet section cooling fill 236. This cooled water may then be fed again to at least a refrigeration system, an air separation unit inlet cooling system, and/or any other process application requiring heat exchange. In some embodiments, a plurality of sensors (not shown) may be positioned within the water tank 238 to monitor the cooled water liquid level and/or the impurity concentration within the cooled water. If the impurity concentration is higher than a predetermined threshold, a blowdown may occur to clean out the impurities and may recycle the cleaned cooled water back into the water tank 238.

Additionally, according to some embodiments, the wet section 230 may comprise a wet section drift eliminator 240 located above the water distribution device 234. The wet section drift eliminator 240 is designed to reduce or prevent drifting of water droplets that is contained in the ambient air that is forcibly being discharged from the wet section 230 to the dry section 260.

As previously mentioned, according to some embodiments, the wet section 230 may also comprise the plurality of wet section fans 222 and the wet section fan motor 223 for each of the plurality of wet section fans 222. The plurality of wet section fans 222 may be located within or in the vicinity of the at least one wet section air inlet 220. The plurality of wet section fans 222 assist in forcing the ambient air from the atmosphere into the wet section 230. In the situation where the at least one wet section air inlet 220 is a continuous wet section air inlet, the plurality of wet section fans 222 may be uniformly spaced apart around the continuous wet section air inlet. Although some embodiments may have the plurality of wet section fans 222 uniformly spaced apart, the plurality of wet section fans 222 may be arbitrarily spaced apart around the continuous wet section air inlet without departing from the scope and spirit of the exemplary embodiment. In the situation where the at least one wet section air inlet 220 is partitioned into several wet section air inlets, the plurality of wet section fans 222 may be positioned such that each wet section air inlet has a single wet section fan. Although some embodiments may have a single wet section fan for each wet section air inlet, alternative embodiments may have a plurality of wet section fans 222 spaced apart, either uniformly or arbitrarily, within each of the wet section air inlets without departing from the scope and spirit of the exemplary embodiment.

The wet section fan motor 223 is associated for each of the plurality of wet section fans 222. The wet section fan motor 223 may be a variable speed motor so that the speed of the corresponding wet section fan may be controlled and made faster or slower depending upon the process requirements.

Additionally, according to some embodiments, the wet section 230 may comprise at least one wet section sound attenuator 226 surrounding at least a portion of the perimeter of the wet section 230. The at least one wet section sound attenuator 226 is designed to reduce the noise created within the cell type hybrid cooling tower 200. The at least one wet section sound attenuator 226 may surround the entire perimeter of the wet section 230 as a continuous sound attenuator or may be partitioned into several sound attenuators surrounding the perimeter of the wet section 230. Although wet section sound attenuators are shown at the perimeter of the wet section 230, other sound reduction devices may be positioned at the perimeter of the wet section 230 without departing from the scope and spirit of the exemplary embodiment. Alternatively, according to some embodiments, there may be no wet section sound attenuators positioned at the perimeter of the wet section 230 without departing from the scope and spirit of the exemplary embodiment.

The dry section 260 is located above the wet section 230 and comprises at least one dry section air inlet 216, a plurality of finned tube heat exchangers 214, a plurality of mixing elements 266, a hot air passageway 268, a stack 270, and a cooling tower fan 272 comprising a cooling tower fan motor 274. Additionally, the dry section 260 may comprise a dry section sound attenuator 269 located at the interface between the dry section 260 and the wet section 230. Additionally, according to some embodiments, the dry section 260 may also comprise at least one dry section shutter door 262 adjacent to the at least one dry section air inlet 216. Furthermore, according to some embodiments, the dry section 260 may also comprise a plurality of dry section fans 218 and a dry section fan motor 219 for each of the plurality of dry section fans 218. Moreover, according to some embodiments, the dry section 260 may also comprise at least one dry section perimeter sound attenuator 264 surrounding at least a portion of the perimeter of the dry section 260.

The at least one dry section air inlet 216 communicates ambient air from the exterior surroundings of the cell type hybrid cooling tower 200 to within the dry section 260. The at least one dry section air inlet 216 may surround the entire dry section 260 as a continuous dry section air inlet or may be partitioned into several dry section air inlets surrounding the dry section 260.

The plurality of finned tube heat exchangers 214 are positioned to surround the entire dry section 260 of the cell type hybrid cooling tower 200. According to this embodiment, the plurality of finned tube heat exchangers 214 are positioned vertically so that the ambient air entering the dry section 260 first passes across the plurality of finned tube heat exchangers 214 prior to passing through the at least one dry section air inlet 216. As a result of the ambient air passing across the plurality of finned tube heat exchangers 214, a first portion of the hot cooling water passing within the plurality of finned tube heat exchangers 214 is cooled and the ambient air passing across the plurality of finned tube heat exchangers 214 is heated. The heated ambient air is then forced through the at least one dry section air inlet 216, either by the plurality of dry section fans 218, the cooling tower fan 272, or both. Although FIG. 2 depicts the plurality of finned tube heat exchangers 214 positioned on the exterior side of the at least one dry section air inlet 216, the plurality of finned tube heat exchangers 214 may be positioned within or on the interior side of the at least one dry section air inlet 216 without departing from the scope and spirit of the exemplary embodiment. Although some embodiments may utilize the plurality of finned tube heat exchangers 216, alternative embodiments may utilize different types of heat exchangers or a combination of various types of heat exchangers without departing from the scope and spirit of the exemplary embodiment. Additionally, although the plurality of finned tube heat exchangers 214 are illustrated as positioned vertically, the plurality of finned tube heat exchangers 214 may be positioned at any angle varying from horizontal to vertical without departing from the scope and spirit of the exemplary embodiment.

The plurality of mixing elements 266 are located adjacent to the at least one dry section air inlet 216 and are designed to mix the heated ambient air passing through the at least one dry section air inlet 216 with the saturated heated ambient air exiting the wet section 230 and entering the dry section 260. This mixing heats the saturated heated ambient air so that it is no longer saturated and therefore plume formation is substantially reduced and/or eliminated.

The hot air passageway 268 is a passageway located at the interface between the wet section 230 and the dry section 260. This hot air passageway 268 allows the rising saturated heated ambient air to communicate from the wet section 230 to the dry section 260. Although this embodiment illustrates that the hot air passageway 268 is continuous, some embodiments may have the hot air passageway 268 partitioned without departing from the scope and spirit of the exemplary embodiment.

The stack 270 is located at the upper portion of the dry section 260 and allows the hot air within the dry section 260 to exit to the atmosphere. The stack typically has a smaller diameter than the bottom portion of the dry section 260.

The cooling tower fan 272 is positioned within the stack 270 and positioned substantially horizontal within the stack. The cooling tower fan 272 comprises the cooling tower fan motor 274 which is typically housed exteriorly of the cell type hybrid cooling water tower 200. Although the cooling tower fan motor 274 is typically housed exteriorly of the cell type hybrid cooling water tower 200, the cooling tower fan motor 274 may be housed on the interior side of the cell type hybrid cooling water tower 200, so long as that the cooling tower fan motor 274 is protected from the moisture within the hot air exiting the stack 270, without departing from the scope and spirit of the exemplary embodiment. The cooling tower fan 272 generates enough power to force air flow into each of the wet section 230 and the dry section 260 from the atmosphere surrounding the cell type hybrid cooling tower 200 and help force the hot air within the dry section to exit the top of the stack 270. The cooling tower fan motor 274 is associated with the cooling tower fan 272 and may be a variable speed motor so that the speed of the fan may be controlled and made faster or slower depending upon the process requirements.

As previously mentioned, the dry section 260 may comprise a dry section sound attenuator 269 located at the interface between the dry section 260 and the wet section 230. The dry section sound attenuator 269 is designed to reduce the noise created within the cell type hybrid cooling tower 200. Although a dry section sound attenuator 269 is shown at the interface between the wet section 230 and the dry section 260, other sound reduction devices may be positioned at the interface between the wet section 230 and the dry section 260 without departing from the scope and spirit of the exemplary embodiment. Alternatively, according to some embodiments, there may be no dry section sound attenuators positioned at the interface between the wet section 230 and the dry section 260 without departing from the scope and spirit of the exemplary embodiment.

Also previously mentioned, according to some embodiments, the dry section 260 may also comprise at least one dry section shutter door 262, or dry section louver, adjacent to the at least one dry section air inlet 216. The at least one dry section shutter door 262 may surround the entire perimeter of the dry section 260 as a continuous dry section shutter door or may be partitioned into several dry section shutter doors surrounding the dry section 260, wherein each of the dry section shutter door corresponds to each of the at least one dry section air inlet 216. The at least one dry section shutter door 262 controls and guides the inflow of the ambient air into the dry section 260 of the cell type hybrid cooling tower 200. The at least one dry section shutter door 262 may be adjustable to be fully closed, partially open, or fully open depending upon the process requirements. However, generally, this at least one dry section shutter door 262 is fully open. Thus, some embodiments may not have the at least one dry section shutter door 262 without departing from the scope and spirit of the exemplary embodiment. This at least one dry section shutter door 262 controls how much of the ambient air is allowed to enter the dry section 260. Although the at least one dry section shutter door 262 has been illustrated as being located on the exterior side of the at least one dry section air inlet 216, the at least one dry section shutter door 262 may be located on the interior side or within the at least one dry section air inlet 216 without departing from the scope and spirit of the exemplary embodiment.

Also previously mentioned, according to some embodiments, the dry section 260 may also comprise a plurality of dry section fans 218 and the dry section fan motor 219 for each of the plurality of dry section fans 218. The plurality of dry section fans 218 may be located within or in the vicinity of the at least one dry section air inlet 216. The plurality of dry section fans 218 assist in forcing the ambient air from the atmosphere into the dry section 260. In the situation where the at least one dry section air inlet 216 is a continuous dry section air inlet, the plurality of dry section fans 218 may be uniformly spaced apart around the continuous dry section air inlet. Although some embodiments may have the plurality of dry section fans 218 uniformly spaced apart, the plurality of dry section fans 218 may be arbitrarily spaced apart around the continuous dry section air inlet without departing from the scope and spirit of the exemplary embodiment. In the situation where the at least one dry section air inlet 216 is partitioned into several dry section air inlets, the plurality of dry section fans 218 may be positioned such that each dry section air inlet has a single dry section fan. Although some embodiments may have a single dry section fan for each dry section air inlet, alternative embodiments may have a plurality of dry section fans 218 spaced apart, either uniformly or arbitrarily, within each of the dry section air inlets without departing from the scope and spirit of the exemplary embodiment.

The dry section fan motor 219 is associated for each of the plurality of dry section fans 218. The dry section fan motor 219 may be a variable speed motor so that the speed of the corresponding dry section fan may be controlled and made faster or slower depending upon the process requirements.

Also previously mentioned, according to some embodiments, the dry section 260 may also comprise at least one dry section perimeter sound attenuator 264 surrounding at least a portion of the exterior perimeter of the dry section 260. The at least one dry section perimeter sound attenuator 264 is designed to reduce the noise created within the cell type hybrid cooling tower 200. The at least one dry section perimeter sound attenuator 264 may surround the entire exterior perimeter of the dry section 260 as a continuous perimeter sound attenuator or may be partitioned into several perimeter sound attenuators surrounding the exterior perimeter of the dry section 260. Although dry section perimeter sound attenuators are shown at the exterior perimeter of the dry section 260, other sound reduction devices may be positioned at the exterior perimeter of the dry section 260 without departing from the scope and spirit of the exemplary embodiment. Alternatively, according to some embodiments, there may be no dry section perimeter sound attenuators positioned at the exterior perimeter of the dry section 260 without departing from the scope and spirit of the exemplary embodiment.

Although FIG. 1 depicts a round hybrid cooling tower 100 and FIG. 2 depicts a cell type hybrid cooling tower 200, the hybrid cooling tower may be of any geometric shape without departing from the scope and spirit of the exemplary embodiment.

Hereafter, a process system utilizing the hybrid cooling tower 100, 200 in accordance with an exemplary embodiment will be described in detail. Since the round hybrid cooling tower 100 and the cell type hybrid cooling tower 200 are essentially designed to operate and function in similar manners, the process systems for each of these hybrid cooling towers will be described together. The process described below is utilized to minimize or eliminate plume formation and to conserve water usage within the both types of hybrid cooling towers 100, 200. The example of the process system described below is provided in regards to supplying cooling water to a gasification plant utilizing a steam turbine to produce power and a refrigeration/ice making system to provide power during at least the peak time periods. The refrigeration/ice making system is provided in further detail in U.S. patent application Ser. No. 12/351,515, entitled “Power Management for Gasification Facility” and filed on Jan. 9, 2009, which has been incorporated by reference herein.

A generalized operational method of the hybrid cooling towers 100, 200 will be provided first followed by a detailed operational method of the hybrid cooling towers 100, 200 for each of the following time periods: summer peak price periods, winter peak price periods, and offpeak price periods.

Generally, cooled water from the water tank 138, 238 exits the water tank 138, 238 and proceeds to at least one main cooling water pump 182 via a main cooling water pump suction line 180, 280. The at least one main cooling water pump 182 pumps the cooled water to any equipment requiring cooled water, which may include, but is not limited to, a turbine condenser 186, a refrigeration/ice making system, an air separation unit, and/or any other equipment requiring heat exchange, via a main cooling water pump discharge line 184. The temperature of the cooled water generally may range from about 85° F. to about 90° F. depending upon the time of year. However, the temperature of the cooled water may deviate from this range without departing from the scope and spirit of the exemplary embodiment.

Once the equipment requiring cooled water has utilized the cooled water in a heat exchange process, the cooled water is transformed into hot water. The hot water is recycled back to the hybrid cooling tower 100, 200 for further cooling. The temperature of the hot water generally may range from about 97° F. to about 107° F. depending upon the time of year. However, the temperature of the hot water may deviate from this range without departing from the scope and spirit of the exemplary embodiment. The hot water exits the equipment through a hot water return line 188, 288, which branches into a wet section hot water return line 189, 289 and a dry section hot water return line 190, 290.

The dry section hot water return line 190, 290 is fluidly coupled to the plurality of finned tube heat exchangers 114, 214 where it is latently cooled by the ambient air passing across the plurality of finned tube heat exchangers 114, 214. In some embodiments, a booster pump 192 may be located in the dry section hot water return line 190, 290 to provide additional pressure to the hot water going through the plurality of finned tube heat exchangers 114, 214. Typically the at least one dry section shutter door 162, 262 is substantially fully open, or not installed, to allow the maximum latent cooling to occur within the plurality of finned tube heat exchangers 114, 214, which thereby minimizes water consumption. The cooled hot water then exits the plurality of finned tube heat exchangers 114, 214 through a dry section cooled hot water return line 191, 291 and is then fed into the wet section hot water return line 189, 289. As the ambient air passes across the plurality of finned tube heat exchangers 114, 214, the ambient air becomes heated ambient air and enters the dry section 160, 260 for providing additional heat to the saturated ambient air exiting the wet section 130 and entering the dry section 160. This additional heat provided by the heated ambient air further heats the saturated ambient air so that plume formation exiting the stack 170, 270 is minimized or eliminated. The heated ambient air and the saturated ambient air are mixed via the plurality of mixing elements 166, 266.

The wet section hot water return line 189, 289 is fluidly coupled to the water distribution device 134, 234 where it is sprayed into the wet section 130, 230 from the plurality of nozzles 134b, 234b. The sprayed hot water enters the wet section cooling fill 136, 236, where it undergoes evaporative cooling due to the heat transfer occurring between the hot water and the ambient air entering the wet section 160, 260. The sprayed hot water is then transformed into cooled water and falls into the water tank 138, 238. A plurality of wet section fans 122, 222 may be installed around the wet section 130, 230 to facilitate the inflow of ambient air into the wet section 130, 230. The plurality of wet section fans 122, 222 comprise a wet section fan motor 123, 223 that is variable speed for increasing or decreasing the inflow of ambient air into the wet section 130, 230. Typically, the at least one wet section shutter door 132, 232, located adjacent to the plurality of wet section fans 122, 222, ranges from fully open to fully closed depending upon the time of year and the location. Typically, the amount of evaporative cooling occurring within the wet section 130, 230 is attempted to be minimized by forcing more of the hot water to undergo latent cooling through the plurality of finned tube heat exchangers 114, 214, thereby minimizing water consumption. Evaporative cooling consumes substantially more water than cooling performed by latent heat transfer. As the ambient air passes across the wet section cooling fill 136, 236, the ambient air becomes saturated ambient air and rises up into the dry section 160, 260 through the wet section drift eliminator 140, 240 and the hot air passageway 168, 268. As previously mentioned, this saturated ambient air is then mixed with the heated ambient air within the dry section 160, 260 prior to exiting the stack 170, 270.

The detailed operational method of the hybrid cooling towers 100, 200 for the various time periods throughout the year, according to one embodiment, will now be discussed. As discussed in more detail in U.S. patent application Ser. No. 12/351,515, entitled “Power Management for Gasification Facility” and filed on Jan. 9, 2009, which has been incorporated by reference herein, the system and method for managing the power of the gasification plant operates, according to one embodiment, by shifting the cooling load from being constant throughout the day to increasing the cooling load during the offpeak price period and decreasing the cooling load from the hybrid cooling tower 100, 200 during the peak price period. Specifically, during the offpeak price period, a portion of the cooling load from the hybrid cooling tower 100, 200 is used in the refrigeration/ice making system to generate ice, which may later be used during at least the peak price period to provide cooling load to certain systems within the gasification plant. Thus, during the peak price period, the cooling load from the hybrid cooling tower 100, 200 is reduced because the refrigeration/ice making system does not require it and the refrigeration/ice making system provides additional cooling loads to some of the systems within the gasification plant.

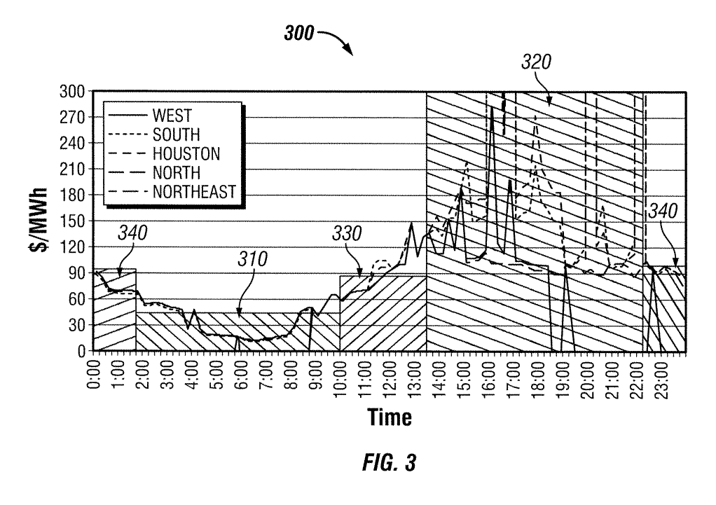

Now referring to FIG. 3, FIG. 3 is a graph 300 illustrating an exemplary embodiment of wholesale power pricing in and around Houston, Tex., USA, for a single day in June, 2008. The graph 300 shows the price per megawatt hour (MWh) vs. time of day. The power pricing is at a minimum during offpeak price period 310, or nighttime. The minimum price for power during the day is about $13/MWh. The offpeak price period 310 typically occurs between about 2:00 a.m. and about 10:00 a.m. The power pricing is at a maximum during peak price period 320, or daytime. The maximum price for power during the day is about $3227/MWh. The peak price period 320 typically occurs between about 2:00 p.m. and about 10:00 p.m. Mid-peak price period 330 occurs between about 10:00 a.m. and about 2:00 p.m. and mid-peak price period 340 occurs between about 10:00 p.m. and about 2:00 a.m.

In certain alternative embodiments, the offpeak price period 310 begins at about 12:00 a.m. and ends at about 7:00 a.m. or begins at about 1:00 a.m. and ends at about 9:00 a.m. In certain alternative embodiments, the peak price period 320 begins at about 10:00 a.m. and ends at about 6:00 p.m. In certain alternative embodiments, the mid-peak price period 330 begins at about 7:00 a.m. and ends at about 10:00 a.m. In certain alternative embodiments, the mid-peak price period 340 begins at 6:00 p.m. and ends at 12:00 a.m. One having ordinary skill in the art can determine the offpeak, peak, and mid-peak price periods of a given day based on the power needs of a supplied area. Thus, these time periods may vary depending upon area location and demand requirements. According to the descriptions provided below, offpeak price periods, summer and winter, include the mid-peak price periods.

Now referring to FIGS. 1, 2, and 3, during summer peak price periods (daytime), the gasification plant has a reduced cooling load since the air separation unit and the refrigeration/ice making system are operated at minimum electrical loads. The air separation unit and the refrigeration/ice making system are able to operate at minimum electrical loads during the summer peak price periods because cooling for the refrigeration/ice making system occurs during the offpeak price period, which is typically nighttime, when the ambient air is cooler and closer to the dew point temperature thereby allowing more latent cooling and less evaporative cooling. This, in and of itself, results in about a 20-30% reduction in cooling tower duty. In order to maximize steam turbine power production, the cooling water temperature leaving the hybrid cooling tower 100, 200 is maintained as low as possible, which in one embodiment may typically be about 85° F. Additionally, the circulation rate is set to achieve minimal temperature rise across the steam turbine, which in one embodiment may typically be about less than 12° F.

During summer peak price periods, the hybrid cooling tower may be operated with both the plurality of dry section fans 118, 218 and the plurality of wet section fans 122, 222 at the maximum rate. This operational method produces the maximum amount of cooling, but also results in the highest evaporation loss or water consumption. As previously mentioned, evaporative losses occur in the wet section 130, 230 and since the plurality of wet section fans 122, 222 are being operated at the maximum rate, maximum water loss is occurring during this period. Producing maximum power during summer peak price periods is important due to the high price of peak power.

During winter peak price periods (daytime), the gasification plant also has a reduced cooling load since the air separation unit and the refrigeration/ice making system are operated at minimum electrical loads. During this price period, the hybrid cooling tower may be operated with the plurality of dry section fans 118, 218 at the maximum rate and the plurality of wet section fans 122, 222 at a reduced rate. Since the ambient air is cooler, a larger quantity of the hot water return is diverted to the plurality of finned tube heat exchangers 114, 214 so that more cooling is performed by latent cooling in the dry section 160, 260, rather than by evaporative cooling in the wet section 130, 230. This method requires that the plurality of wet section fans 122, 222 be equipped with the % vet section fan motor 123, 223 being a variable speed motor or a two speed motor. Additionally, the wet section 130, 230 also requires that there be the at least one wet section shutter door 132, 232 installed for decreasing the amount of ambient air entering the wet section 130, 230. In order to reduce water consumption or evaporation during the winter peak pricing periods, the cooling water temperature leaving the hybrid cooling tower 100, 200 and the temperature rise are maintained at the same level as the summer peak price periods. Thus, according to one embodiment, the cooling water temperature leaving the hybrid cooling tower 100, 200 may typically be about 85° F. and the temperature rise across the steam turbine may typically be about less than 12° F. This operational method maintains design summer steam turbine power output at winter conditions, but with reduced evaporation.

During offpeak price periods (nighttime) occurring throughout the year, the gasification plant has an increased cooling load when compared to the peak price periods since the air separation unit and the refrigeration/ice making system are operated at maximum electrical load. This operational method results in a 10-20% increase in cooling water duty. In order to minimize water consumption, or evaporation, during offpeak price periods, the cooling water temperature leaving the hybrid cooling tower 100, 200 is allowed to be increased, which in one embodiment may typically be about 90° F. Additionally, the circulation rate is maintained at the same rate as the peak price period operation, which results in a higher cooling water temperature rise, which in one embodiment may typically be about 17° F. or above, across the steam turbine due to the increased cooling water duty. During this price period, the hybrid cooling tower 100, 200 may be operated with the plurality of dry section fans 118, 218 at the maximum rate and the plurality of wet section fans 122, 222 at a reduced rate. Since the ambient air is cooler during this period, a larger quantity of the hot water return is diverted to the plurality of finned tube heat exchangers 114, 214 so that more cooling is performed by latent cooling in the dry section 160, 260, rather than by evaporative cooling in the wet section 130, 230. This method requires that the plurality of wet section fans 122, 222 be equipped with the wet section fan motor 123, 223 being a variable speed motor or a two speed motor. Additionally, the wet section 130, 230 also requires that there be the at least one wet section shutter door 132, 232 installed for decreasing the amount of ambient air entering the wet section 130, 230. This operational method minimizes evaporation loss, but reduces the efficiency of the steam turbine due to the higher cooling water temperature. Conserving water during offpeak price periods is important to minimize annual water consumption, with minimal loss of power revenue.

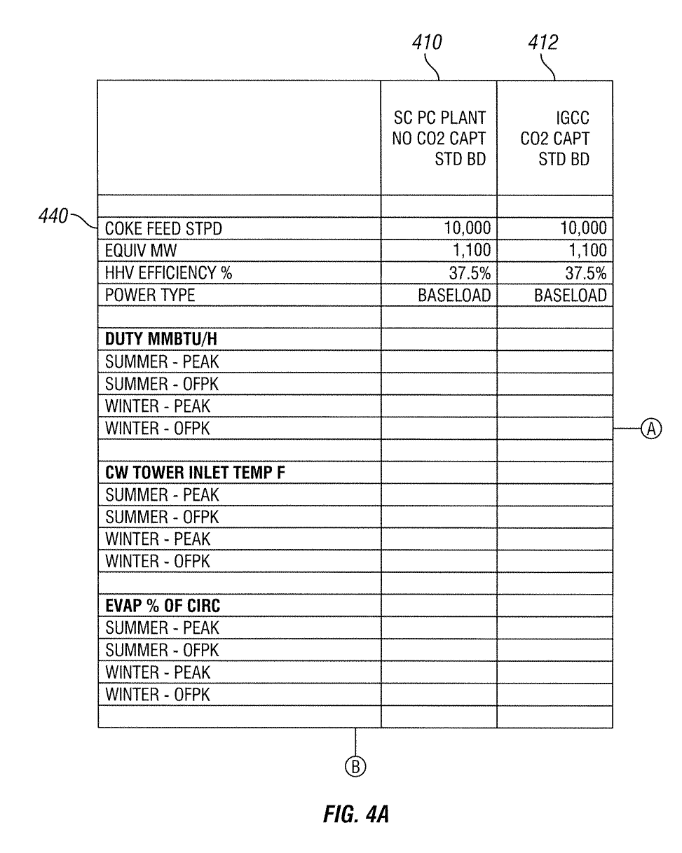

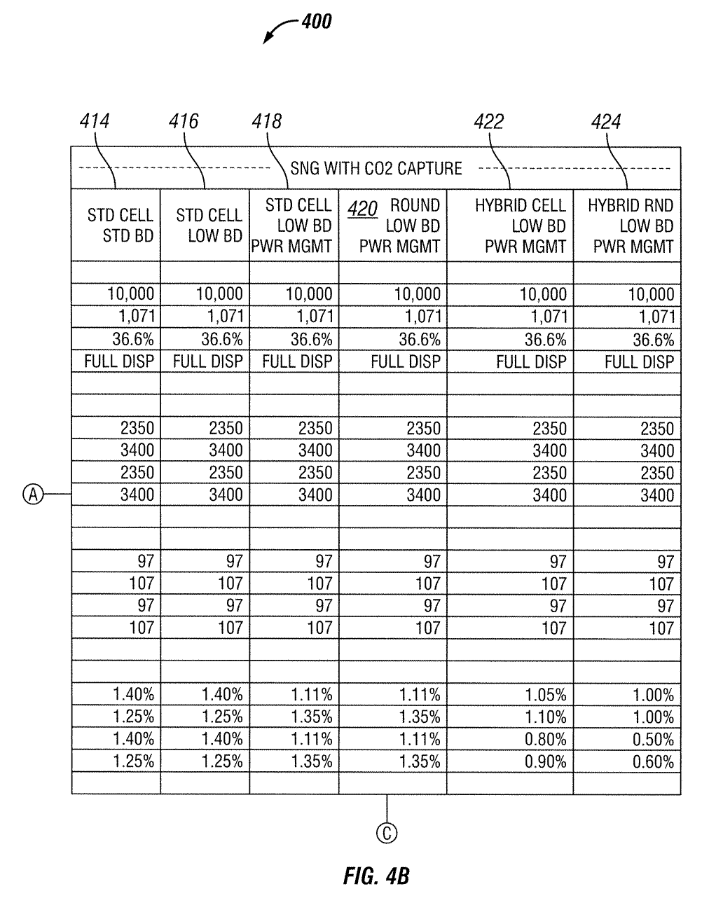

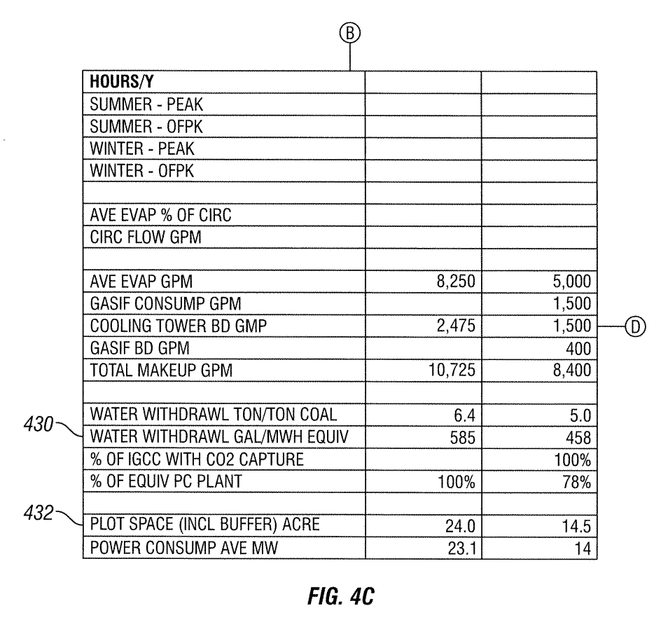

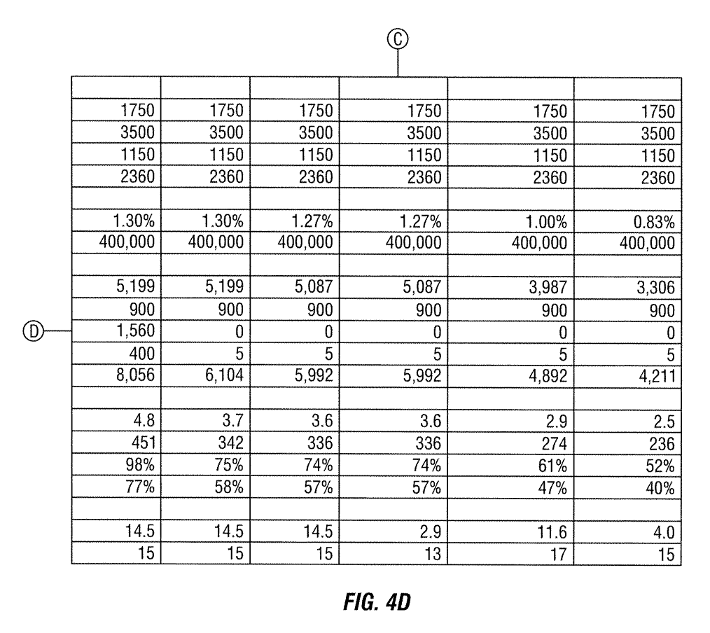

FIG. 4 shows a table 400 comparing the operating requirements, including water consumption requirements and land space requirements for various types of power producing plants in accordance with an exemplary embodiment. The various types of power producing plants include sub-critical pulverized coal plant with no CO₂ capture and standard blowdown (“SCPC Plant”) 410, integrated gasification combined cycle plant with CO₂ capture and standard blowdown (“IGCC Plant”) 412, substitute natural gas plant with CO₂ capture, standard blowdown, and utilizing a standard cell type cooling tower (“SNG_SC_SBD Plant”) 414, substitute natural gas plant with CO₂ capture, low blowdown, and utilizing a standard cell type cooling tower (“SNG_SC_LBD Plant”) 416, substitute natural gas plant with CO₂ capture, low blowdown, and utilizing a standard cell type cooling tower with power management (“SNG_SC_LBD_PM Plant”) 418, substitute natural gas plant with CO₂ capture, low blowdown, and utilizing a round type cooling tower with power management (“SNG_R_LBD_PM Plant”) 420, substitute natural gas plant with CO₂ capture, low blowdown, and utilizing a hybrid cell type cooling tower with power management (“SNG_HC_LBD_PM Plant”) 422, and substitute natural gas plant with CO₂ capture, low blowdown, and utilizing a hybrid round type cooling tower with power management (“SNG_HR_LBD_PM Plant”) 424. There is no waste water stream that is generated when using the power management.

Although various types of data are provided for each of the different types of power producing plants, attention will be provided to the water withdrawal, or water consumption requirements, (gal/megawatt-hour equivalence) 430 and the plot space including buffer area, or land space requirements, (acre) 432. The data provided is based upon 10,000 tons/day of coke feed 440.

With respect to water consumption requirements 430 and as illustrated in table 400, the SCPC Plant 410 consumes about 585 gallons of water/megawatt-hour equivalence, the IGCC Plant 412 consumes about 458 gallons of water/megawatt-hour equivalence, the SNG_SC_SBD Plant 414 consumes about 451 gallons of water/megawatt-hour equivalence, the SNG_SC_LBD Plant 416 consumes about 342 gallons of water/megawatt-hour equivalence, the SNG_SC_LBD_PM Plant 418 consumes about 336 gallons of water/megawatt-hour equivalence, the SNG_R_LBD_PM Plant 420 consumes about 336 gallons of water/megawatt-hour equivalence, the SNG_HC_LBD_PM Plant 422 consumes about 274 gallons of water/megawatt-hour equivalence, and the SNG_HR_LBD_PM Plant 424 consumes about 236 gallons of water/megawatt-hour equivalence. Thus, the hybrid cooling towers 100, 200 utilizing power management conserves substantially more water than the other types of power producing plants. Additionally, the hybrid cooling towers 100, 200 utilizing power management conserves substantially more water than the other types of power producing plants having standard cell type cooling towers or round type cooling towers utilizing power management. Table 400 also shows that the total make up water is less for the SNG_HC_LBD_PM Plant 422 and the SNG_HR_LBD_PM Plant 424 when compared to the other types of power producing plants due to the reduced evaporation occurring within the SNG_HC_LBD_PM Plant 422 and the SNG_HR_LBD_PM Plant 424.

With respect to land space requirements 432 and as illustrated in table 400, the SCPC Plant 410 requires about 24.0 acres of land, the IGCC Plant 412 requires about 14.5 acres of land, the SNG_SC_SBD Plant 414 requires about 14.5 acres of land, the SNG_SC_LBD Plant 416 requires about 14.5 acres of land, the SNG_SC_LBD_PM Plant 418 requires about 14.5 acres of land, the SNG_R_LBD_PM Plant 420 requires about 2.9 acres of land, the SNG_HC_LBD_PM Plant 422 requires about 11.6 acres of land, and the SNG_HR_LBD_PM Plant 424 requires about 4.0 acres of land. Thus, the hybrid cooling towers 100, 200 utilizing power management requires substantially less than the other types of power producing plants utilizing corresponding standard cell type cooling towers or round type cooling towers. Additionally, the round type cooling towers, especially the hybrid round type cooling towers, perform the best for requiring the least amount of land.

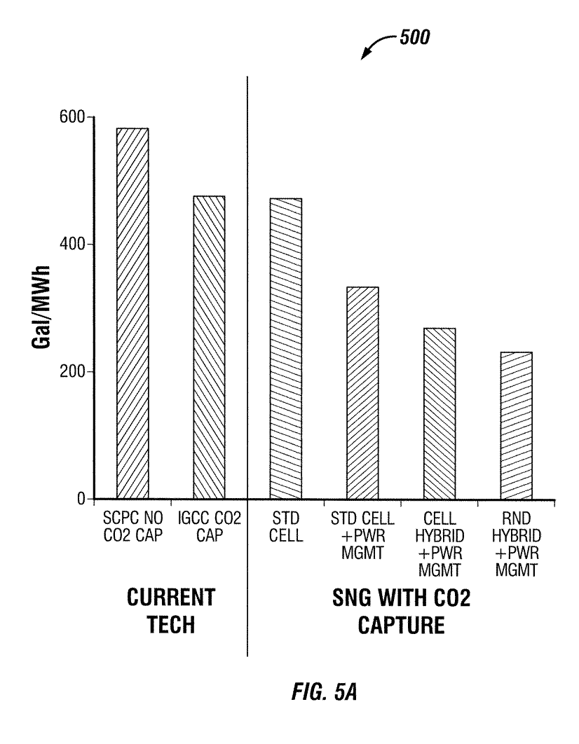

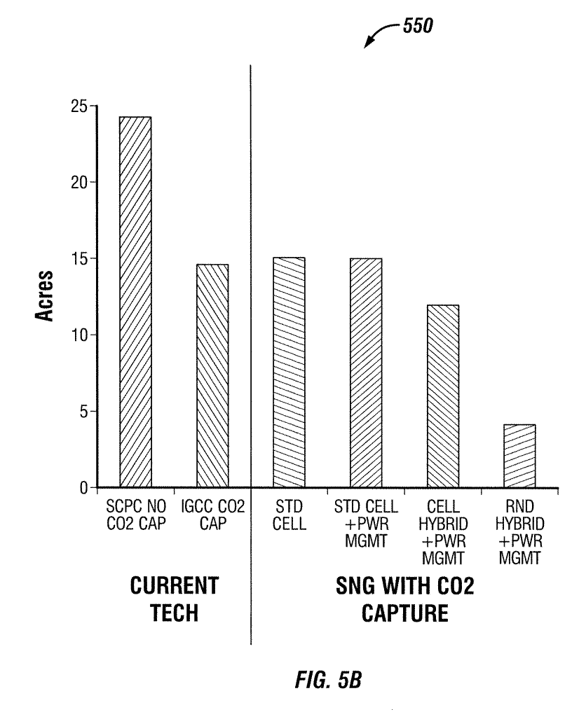

FIG. 5A shows a bar chart 500 comparing water consumption requirements in the various types of power plants in accordance with an exemplary embodiment provided in FIG. 4. FIG. 5B shows a bar chart 550 comparing land requirements for various types of power plants in accordance with an exemplary embodiment provided in FIG. 4. The information provided in FIGS. 5A and 5B are the same as those provided in FIG. 4, except that the information is provided in a bar chart. The information provided is based upon 10,000 tons per day of coke feed. Also, the information provided for the SNG options assume remote NGCC plant with plot space to allow finned tube heat exchangers or equivalent heat exchangers.

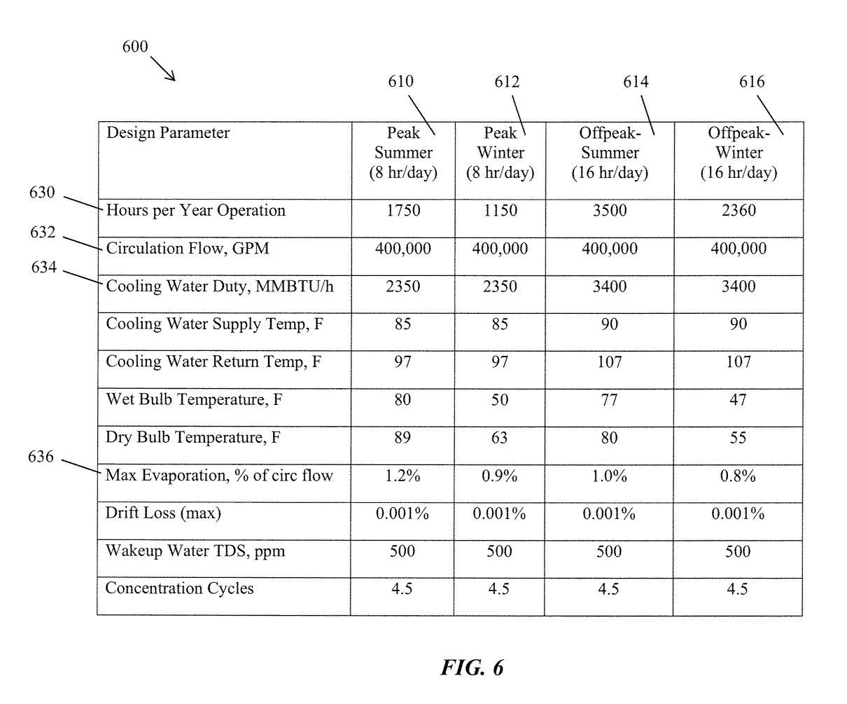

FIG. 6 shows a table 600 depicting various design parameters of a hybrid cooling tower 100, 200 (FIG. 1, FIG. 2) for various time periods throughout the year in accordance with an exemplary embodiment. The different time periods throughout the year include peak summer 610, which is about 8 hours/day, peak winter 612, which is about 8 hours/day, offpeak summer 614, which is about 16 hours/day, and offpeak winter 616, which is about 16 hours/day. In this illustration, the peak summer 610 is equivalent to the peak price period during the summer, the peak winter 612 is equivalent to the peak price period during the winter, the offpeak summer 614 is equivalent to the offpeak price period and the mid-peak price periods during the summer, and the offpeak winter 616 is equivalent to the offpeak price period and the mid-peak price periods during the winter.

Although various types of data are provided for each of the different time periods throughout the year, particular attention will be provided to the hours per year operation (hours) 630, the circulation flow (gallons/minute) 632, the cooling water duty (MMBtu/hour) 634, and maximum evaporation (percent of circulation flow) 636.

With respect to the hours per year operation 630 and as illustrated in table 600, the peak summer 610 is estimated to be about 1750 hours/year, the peak winter 612 is estimated to be about 1150 hours per year, the offpeak summer 614 is estimated to be about 3500 hours per year, and the offpeak winter 616 is estimated to be about 2360 hours per year.

With respect to the circulation flow 632, the circulation flow 632 is maintained at about 400,000 gallons/minute throughout all time periods during the year.

With respect to the cooling water duty 634, the peak summer 610 and the peak winter 612 are estimated to be about 2350 MMBtu/hour and the offpeak summer 614 and the offpeak winter 616 are estimated to be about 3400 MMBtu/hour. Thus, it may be seen that the cooling water duty is higher during offpeak periods than for peak periods because more cooling water duty is required for the refrigeration/ice making system and the air separation unit during the offpeak periods than for the peak periods.

With respect to the maximum evaporation 636, the peak summer 610 is estimated to be about 1.2% of the circulation flow, the peak winter 612 is estimated to be about 0.9% of the circulation flow, the offpeak summer 614 is estimated to be about 1.0% of the circulation flow, and the offpeak winter 616 is estimated to be about 0.8% of the circulation flow. Thus, although greater cooling water duty is required during the offpeak periods than for the peak periods, less evaporation occurs during the offpeak summer 614 than for the peak summer 610 and during the offpeak winter 616 than for the peak winter 612. These results are due to the features of the hybrid cooling towers 100, 200 (FIG. 1, FIG. 2) and due to the power management for the gasification plant.

According to some of the embodiments, for an SNG based gasification plant with CO₂ capture and power management system, there may be about a 30% savings in water withdrawal using a hybrid cooling tower that has been modified to allow maximum turndown of the wet section fans. Also, in some embodiments, there also may be no reduction in peak power output from the gasification plant. Additionally, according to some of the embodiments, the makeup and the blowdown water treating streams may be smaller due to the reduced evaporation occurring within the hybrid cooling towers. Furthermore, in some of the embodiments, the operation of the hybrid cooling towers for minimum water consumption eliminates plume and wet drift exiting the stack of the hybrid cooling tower, which thereby eliminates the buffer plot space requirement and allows for water/freeze sensitive equipment to be located adjacent to the hybrid cooling towers. This operational method allows for a more optimized overall plot plan. Moreover, according to some of the embodiments, the use of the hybrid cooling towers substantially reduces the hybrid cooling towers' footprint due to the elimination of the plume buffer area.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims. It is therefore, contemplated that the claims will cover any such modifications or embodiments that fall within the scope of the invention.

What is claimed is:

1. A hybrid cooling tower, comprising:
a wet section comprising:
at least one wet section air inlet; and
at least one wet section shutter door adjacent the at least one wet section air inlet, the at least one wet section shutter door being adjustable to assist in controlling the amount of ambient air entering through the at least one wet section air inlet; and
a dry section adjacently positioned above the wet section, the dry section fluidly communicable with the wet section.

2. The hybrid cooling tower of claim 1, wherein the wet section further comprises a plurality of wet section fans and a wet section fan motor corresponding to each of the plurality of wet section fans, wherein the speed of at least a portion of the plurality of wet section fans is adjustable.

3. The hybrid cooling tower of claim 2, wherein the wet section fan motor is a variable speed motor.

4. The hybrid cooling tower of claim 2, wherein the wet section fan motor is a two-speed motor.

5. The hybrid cooling tower of claim 1, further comprising a plurality of exchangers positioned around the perimeter of the hybrid cooling tower, the plurality of exchangers providing latent heat transfer between a portion of a hot water return and the ambient air entering into the dry section, the portion of the hot water return flowing through the plurality of exchangers.

6. The hybrid cooling tower of claim 5, wherein the plurality of heat exchangers comprises a plurality of finned tube heat exchangers.

7. The hybrid cooling tower of claim 1, wherein the dry section comprises:
at least one dry section air inlet; and
a plurality of dry section fans and a dry section fan motor corresponding to each of the plurality of dry section fans, wherein the speed of at least a portion of the plurality of dry section fans is adjustable.

8. The hybrid cooling tower of claim 7, wherein the dry section further comprises at least one dry section shutter door adjacent the at least one dry section air inlet, the at least one dry section shutter door being adjustable to assist in controlling the amount of ambient air entering through the at least one dry section air inlet.

9. The hybrid cooling tower of claim 1, wherein evaporative and latent cooling occurs within the wet section and latent cooling occurs within the dry section.

10. The hybrid cooling tower of claim 1, wherein the hybrid cooling tower is a round type.

11. The hybrid cooling tower of claim 1, wherein the hybrid cooling tower is a cell type.

12. A gasification facility, comprising:
a refrigeration/ice storage system; and
a hybrid cooling tower for supplying a cooled water to the refrigeration/ice storage system.

13. The gasification facility of claim 12, wherein the hybrid cooling tower comprises:
a wet section comprising:
at least one wet section air inlet; and
at least one wet section shutter door adjacent the at least one wet section air inlet, the at least one wet section shutter door being adjustable to assist in controlling the amount of ambient air entering through the at least one wet section air inlet; and
a dry section adjacently positioned above the wet section, the dry section fluidly communicable with the wet section.

14. The gasification facility of claim 13, wherein the wet section further comprises a plurality of wet section fans and a wet section fan motor corresponding to each of the plurality of wet section fans, wherein the speed of at least a portion of the plurality of wet section fans is adjustable.

15. The gasification facility of claim 14, wherein the wet section fan motor is a variable speed motor.

16. The gasification facility of claim 14, wherein the wet section fan motor is a two-speed motor.

17. The gasification facility of claim 13, further comprising a plurality of exchangers positioned around the perimeter of the hybrid cooling tower, the plurality of exchangers providing latent heat transfer between a portion of a hot water return and the ambient air entering into the dry section, the portion of the hot water return flowing through the plurality of exchangers.

18. The gasification facility of claim 17, wherein the plurality of heat exchangers comprises a plurality of finned tube heat exchangers.

19. The gasification facility of claim 13, wherein the dry section comprises:
at least one dry section air inlet; and
a plurality of dry section fans and a dry section fan motor corresponding to each of the plurality of dry section fans, wherein the speed of at least a portion of the plurality of dry section fans is adjustable.

20. The gasification facility of claim 19, wherein the dry section further comprises at least one dry section shutter door adjacent the at least one dry section air inlet, the at least one dry section shutter door being adjustable to assist in controlling the amount of ambient air entering through the at least one dry section air inlet.

21. The gasification facility of claim 13, wherein evaporative cooling occurs within the wet section and latent cooling occurs within the dry section.

22. The gasification facility of claim 13, wherein the hybrid cooling tower is a round type.

23. The gasification facility of claim 13, wherein the hybrid cooling tower is a cell type.

24. A method of operating a hybrid cooling tower comprising:
placing a hybrid cooling tower in fluid communication with at least one equipment requiring cooled water from the hybrid cooling tower, wherein the hybrid cooling tower comprises:
a wet section comprising:
at least one wet section air inlet; and
a plurality of wet section fans adjacent the at least one wet section air inlet, the at least one wet section fan being adjustable to perform at an increased rate and a reduced rate; and
a dry section adjacently positioned above the wet section, the dry section fluidly communicable with the wet section;
adjusting the rate of the plurality of wet section fans depending upon the ambient conditions surrounding the hybrid cooling tower.

25. The method of claim 24, further comprising:
controlling a first amount of hot water return flow rate from the at least one equipment that enters into a plurality of heat exchangers surrounding the perimeter of the hybrid cooling tower versus a second amount of hot water return flow rate from the at least one equipment that enters directly into the wet section, wherein the step of controlling is dependent upon the ambient conditions surrounding the hybrid cooling tower.

26. The method of claim 24, further comprising:
placing an increased cooling load on the hybrid cooling tower during an offpeak price period; and
placing a reduced load on the hybrid cooling tower during a peak price period.

27. The method of claim 24, wherein the peak price period comprises a time period during which power demand is at a maximum and the market price of the power is at a premium.

28. The method of claim 26, wherein the peak price period ranges from about 2:00 p.m. to about 10:00 p.m.

29. The method of claim 26, wherein the peak price period ranges from about 10:00 a.m. to about 6:00 p.m.

30. The method of claim 24, wherein the dry section comprises:
at least one dry section air inlet; and
a plurality of dry section fans adjacent the at least one dry section air inlet.

31. The method of claim 30, wherein the plurality of wet section fans operate at an increased rate and the plurality of dry section fans operate at an increased rate during a summer peak pricing period.

32. The method of claim 30, wherein the plurality of wet section fans operate at a reduced rate and the plurality of dry section fans operate at an increased rate during a winter peak pricing period.

33. The method of claim 30, wherein the plurality of wet section fans operate at a reduced rate and the plurality of dry section fans operate at an increased rate during an offpeak pricing period.

34. The method of claim 24, wherein the at least one equipment requiring cooled water from the hybrid cooling tower comprises a refrigeration/ice making system, wherein the hybrid cooling tower supplies maximum cooling water to the refrigeration/ice making system during the offpeak pricing period.

35. The method of claim 24, wherein the wet section further comprises at least one wet section shutter door adjacent the at least one wet section air inlet, the at least one wet section shutter door being adjustable to assist in controlling the amount of ambient air entering through the at least one wet section air inlet.

36. The method of claim 24, wherein the hybrid cooling tower comprises a round type hybrid cooling tower.

37. The method of claim 24, wherein the hybrid cooling tower comprises a cell type hybrid cooling tower.

38. A gasification facility, comprising:
a hybrid cooling tower for supplying a cooled water to the gasification facility,
wherein the hybrid cooling tower comprises a wet section and a dry section, the dry section adjacently positioned above and fluidly communicable with the wet section, and the wet section comprising:
at least one wet section air inlet; and
at least one wet section shutter door adjacent the at least one wet section air inlet, the at least one wet section shutter door being adjustable to assist in controlling the amount of ambient air entering through the at least one wet section air inlet.

39. The gasification facility of claim 38, wherein the dry section comprises:
at least one dry section air inlet; and
a plurality of dry section fans and a dry section fan motor corresponding to each of the plurality of dry section fans, wherein the speed of at least a portion of the plurality of dry section fans is adjustable.

40. The gasification facility of claim 39, wherein the dry section further comprises at least one dry section shutter door adjacent the at least one dry section air inlet, the at least one dry section shutter door being adjustable to assist in controlling the amount of ambient air entering through the at least one dry section air inlet.
